(19) United States
(12) Patent Application Publication
(10) Pub. No.: US 2002/0018622 A1
(43) Pub. Date: Feb. 14, 2002

(54) Optical waveguide and method of manufacturing the same

(75) Inventors: Kazutaka Nara, Tokyo (JP); Kazuhisa Kashihara, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Chiyoda-ku (JP)

(21) Appl. No.: 09/915,334

(22) Filed: Jul. 27, 2001

(30) Foreign Application Priority Data
Jul. 27, 2000 (JP) 2000-227214

(51) Int. Cl. G02B 6/26

(52) U.S. Cl. 385/37; 385/15; 385/46; 65/386

(57) ABSTRACT

An optical waveguide which can suppress adjacent crosstalk even when wavelength intervals to be multiplexed/demultiplexed are narrow. A lower clad film and a core film are deposited and formed on a substrate (11) by flame hydrolysis deposition, and they are consolidated, whereupon the core film is processed into a waveguide pattern. The waveguide pattern is formed by successively connecting at least one optical input waveguide (12), a first slab waveguide (13), an arrayed waveguide (14) consisting of a plurality of channel waveguides (14a) arranged side by side and having lengths different from one another, a second slab waveguide (15), and a plurality of light output waveguides (16) arranged side by side. The waveguides arranged side by side are at intervals from one another. An upper clad film covering the waveguide pattern is deposited and formed by flame hydrolysis deposition, and it is thereafter consolidated. Herein, a sintering rate in a temperature rise from a temperature at which the density change of the glass particles of the upper clad film starts, to a temperature at which the density change ends, is set at 1.0° C./min or below at the step of consolidating the upper clad film, whereby the arrayal aspect of the channel waveguides (14a) is brought close to an ideal aspect.

### BACKGROUND OF THE INVENTION

In recent years, in optical communications, optical wavelength division multiplexing (WDM) transmission systems have been vigorously researched on and developed and have been being put into practical use, as a method which increases the transmission capacities of the optical communications by leaps and bounds. The optical WDM transmission systems perform the wavelength multiplexing of a plurality of lights having, for example, wavelengths different from one another so as to transmit the multiplexed light. Such an optical WDM transmission systems necessitate an optical multiplexer/demultiplexer which demultiplexes lights of a plurality of wavelengths different from one another from wavelength-multiplexed transmitted light, and which multiplexes lights of a plurality of wavelengths different from one another.

An example of the optical multiplexer/demultiplexer is an arrayed waveguide grating (AWG). The AWG is such that an optical waveguide portion 10 having a waveguide construction (waveguide pattern) as shown in FIG. 9 by way of example is formed on a substrate 11.

The waveguide construction of the AWG is formed having at least one optical input waveguide 12 arranged side by side, a first slab waveguide 13 which is connected to the output side of at least optical input waveguide 12, an arrayed waveguide 14 which consists of a plurality of channel waveguides 14a connected to the output side of the first slab waveguide 13 and arranged side by side, a second slab waveguide 15 which is connected to the output side of the arrayed waveguide 14, and a plurality of optical output waveguides 16 which are arranged side by side and connected to the output side of the second slab waveguide 15.

The channel waveguides 14a propagate lights derived from the first slab waveguide 13, and are formed to have lengths differing preset amounts from one another. Besides, the light input waveguides 12 and the light output waveguides 16 are both formed so as to have uniform diameters, and the diameters of the light input waveguides 12 or the light output waveguides 16 are made substantially equal to one another.

The light output waveguides 16 are disposed in correspondence with, for example, the number of those signal lights of wavelengths different from one another which are demultiplexed by the AWG. Besides, the channel waveguides 14a are usually disposed in a large number of, for example, 100. In FIG. 9, however, the numbers of the waveguides 12, 14a, 16 are decreased for the brevity of illustration.

Optical fibers of, for example, transmission side are connected to the optical input waveguides 12 so as to introduce wavelength-multiplexed light. The light introduced into the first slab waveguide 13 through the light input waveguides 12 are spread by the diffraction effect thereof, to enter the plurality of channel waveguides 14a and be propagated through the arrayed waveguide 14.

The lights propagated through the arrayed waveguide 14 reach the second slab waveguide 15, and are further condensed by the optical output waveguides 16 so as to be outputted. Since the lengths of the respective channel waveguides 14a differ the preset amounts from one another, the phases of the individual lights are shifted after the propagation through the respective channel waveguides 14a, and the phasefronts of the condensed lights are inclined in accordance with the amounts of the shifts. Positions where the lights are condensed are determined by the angles of the inclinations, so that the light condensation positions of the lights of the different wavelengths differ from one another. Accordingly, the optical output waveguides 16 are formed at the light condensation positions of the respective wavelengths, whereby the lights whose wavelengths differ from one another at intervals of predetermined design wavelengths can be outputted from the optical output waveguides 16 separate for the respective wavelengths.

When, as shown in FIG. 9 by way of example, wavelength-multiplexed light having wavelengths λ1, λ2, λ3, . . . λn (where n denotes an integer of at least 2) different from one another at the design wavelength intervals are inputted from one of the optical input waveguides 12, they are spread by the first slab waveguide 13 and then reach the arrayed waveguide 14. Further, the lights are passed through the second slab waveguide 15, and they are condensed at positions different depending upon the wavelengths as explained above, to enter the optical output waveguides 16 different from one another. Subsequently, the lights are passed through the respective optical output waveguides 16 and are outputted from the output ends thereof. Optical fibers for outputting lights are connected to the output ends of the respective optical output waveguides 16, whereby the lights of the respective wavelengths are derived through the optical fibers.

Besides, the arrayed waveguide grating is constructed by utilizing the reciprocity theorem of light. Therefore, the AWG has the function of an optical multiplexer simultaneously with the function of the optical demultiplexer. Contrariwise to the illustration of FIG. 9, when lights of a plurality of wavelengths different from one another at the design wavelength intervals are inputted from the optical output waveguides 16 corresponding to the respective wavelengths, they are passed through propagation paths reverse to the foregoing ones and are multiplexed, and the wavelength-multiplexed light is outputted from one of the optical input waveguides 12.

In the AWG, enhancement in the wavelength resolution of a diffraction grating is proportional to the difference (ΔL) between the lengths of the adjacent ones of the channel waveguides 14a constituting the diffraction grating. It is accordingly permitted by designing the difference ΔL large to optically multiplex/demultiplex the wavelength-multiplexed light at narrow wavelength intervals which have not been realizable with prior-art optical multiplexers/demultiplexers. By way of example, when a design wavelength interval in the case of demultiplexing or multiplexing the lights by enlarging the difference ΔL is set at 1 nm or less, it is possible to fulfill the function of demultiplexing or multiplexing a plurality of light signals whose wavelength intervals are 1 nm or less, and also to fulfill the function of optically multiplexing/demultiplexing a plurality of signal lights as is required for realizing optical wavelength division multiplexing transmission of high density.

### SUMMARY OF THE INVENTION

The present invention provides a method of manufacturing an optical waveguide, and the optical waveguide employing the manufacturing method.

A method of manufacturing an optical waveguide according to the present invention comprises:

the step S1 of forming a predetermined waveguide pattern on a core which overlie a lower clad formed on a substrate;

the step S2 of forming an upper clad film which covers the waveguide pattern, by flame hydrolysis deposition after said step S1; and

the step S3 of consolidating the upper clad film after said step S2;

wherein letting T1 denote a temperature at which a density change of glass particles of said upper clad film starts at said step S3, and

letting T2 denote a temperature at which the density change ends,

a sintering rate in a temperature rise from the temperature T1 to the temperature T2 is set at, at most, 1.0° C./min so as to consolidating said upper clad film.

### BRIEF DESCRIPTION OF THE DRAWINGS

Exemplary embodiments of the invention will now be described in conjunction with drawings, in which:

FIG. 1 is a view showing the construction of essential portions in an embodiment of an optical waveguide according to the present invention;

FIG. 2 is a graph showing an example of the optical spectrum of the arrayed waveguide grating of the embodiment;

FIG. 3 is a graph showing the data of the relationship between a sintering rate at the step of consolidating an upper clad in the manufacture of an optical waveguide and the adjacent crosstalk of an arrayed waveguide grating;

FIG. 4 is a schematic view showing the cross section of an arrayed waveguide in the case where a sintering rate at the step of consolidating an upper clad is heightened in the manufacture of an arrayed waveguide grating;

FIG. 5 is a graph showing a phase errors attendant upon the arrayed waveguide shown in FIG. 4;

FIG. 6 is a graph showing the optical spectrum of the arrayed waveguide grating evaluated on the basis of the simulated result shown in FIG. 5, in comparison with a optical spectrum within the correlative phase errors;

FIG. 7 is a graph showing a density change at the step of consolidating glass particles in the manufacture of an optical waveguide;

FIGS. 8A, 8B, 8C and 8D are schematic views for explaining influence on the cross section of cores attendant upon a temperature rise at the step of consolidating an upper clad in the manufacture of the optical waveguide;

FIG. 9 is an explanatory view showing an example of construction of an arrayed waveguide grating;

FIGS. 10A, 10B, 10C, 10D and 10E are explanatory views showing an example of a process for manufacturing an arrayed waveguide grating;

FIG. 11 is a graph showing an example of the optical spectrum of a 40 ch-50 GHz arrayed waveguide grating produced by a prior-art manufacturing method;

FIG. 12 is a graph showing an example of the optical spectrum of a 40 ch-100 GHz arrayed waveguide grating; and

FIG. 13 is a graph showing the graphs of FIGS. 11 and 12 as are normalized and superposed.

### DETAILED DESCRIPTION

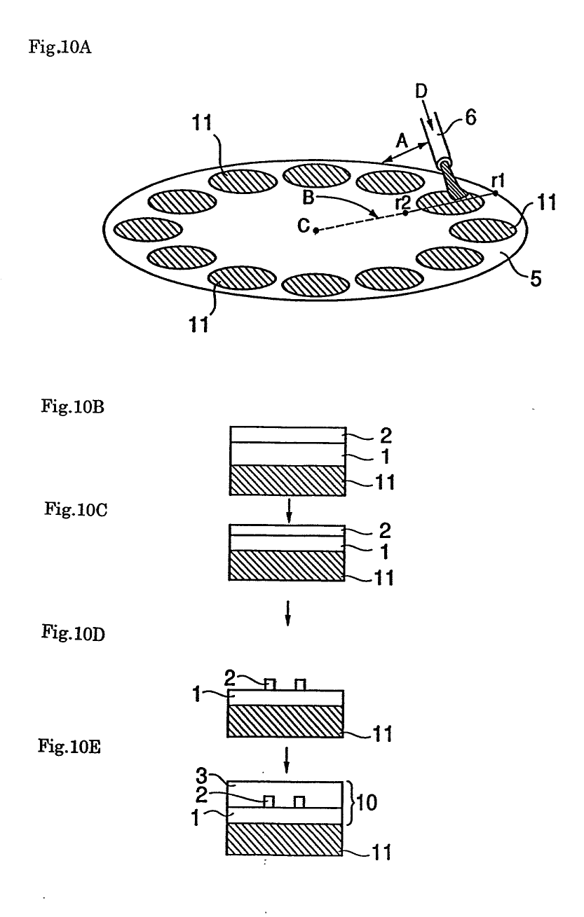

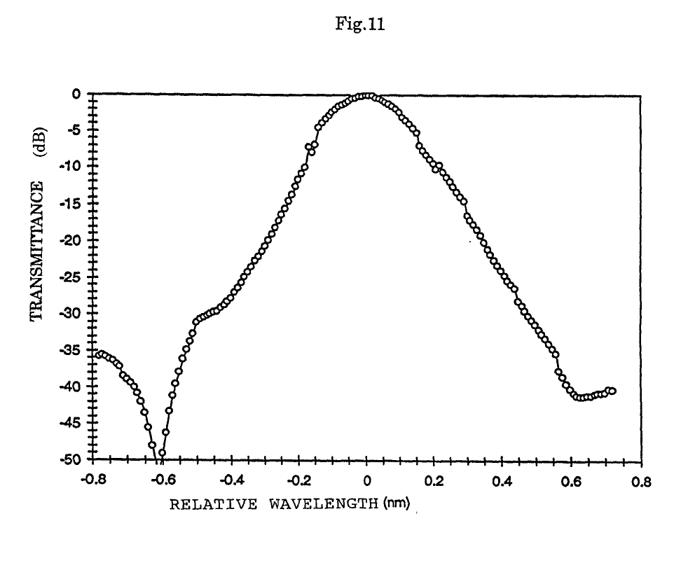

An arrayed waveguide grating (AWG) is produced by a manufacturing method which employs, for example, flame hydrolysis deposition (FHD) explained below. First, as shown in FIG. 10A, one or more substrates 11 are arranged as an array at circumferential positions about the center C of rotation on a turntable 5 which is rotated at a constant angular velocity.

Subsequently, the turntable 5 is rotated in a direction B by way of example, and a burner 6 is reciprocated in the radial direction of the turntable 5 as indicated by an arrow A so as to be reciprocated on each of the substrates 11. While the burner 6 is thus being moved, the raw material gas of a glass, oxygen gas and hydrogen gas are caused to flow from the burner 6 as indicated by an arrow D, so as to cause the hydrolysis reaction of the raw material gas in oxyhydrogen flame and to deposit lower clad glass particles on the substrate 11.

A mixed raw material halogen gas which consists of SiCl₄, BCl₃ and PCl₃, is applied as the raw material gas of the glass for the clad. Besides, the hydrolysis reaction of the raw material gas is caused in the oxyhydrogen flame, and the glass particles of a lower clad (the lower clad glass particles) are deposited on the substrate 11 and formed into a lower clad film.

Thereafter, a mixed raw material halogen gas which consists of SiCl₄, BCl₃, PCl₃ and GeCl₄ and which is the raw material gas of a glass for cores is caused to flow from the burner 6 together with oxygen gas and hydrogen gas. Besides, the hydrolysis reaction of the raw material gas is caused in oxyhydrogen flames, and the glass particles of the cores (core glass particles) are deposited and formed into a core film. FIG. 10B shows a state where the film of the lower clad and the film of the cores have been formed on the substrate 11 in the above way.

A step shown in FIG. 10C is the step of consolidating the lower clad film and the core film. The lower clad glass particles and the core glass particles deposited and formed as explained above are heat-treated at a high temperature of at least 1300 ° C., thereby to consolidate the lower clad 1 and the cores 2.

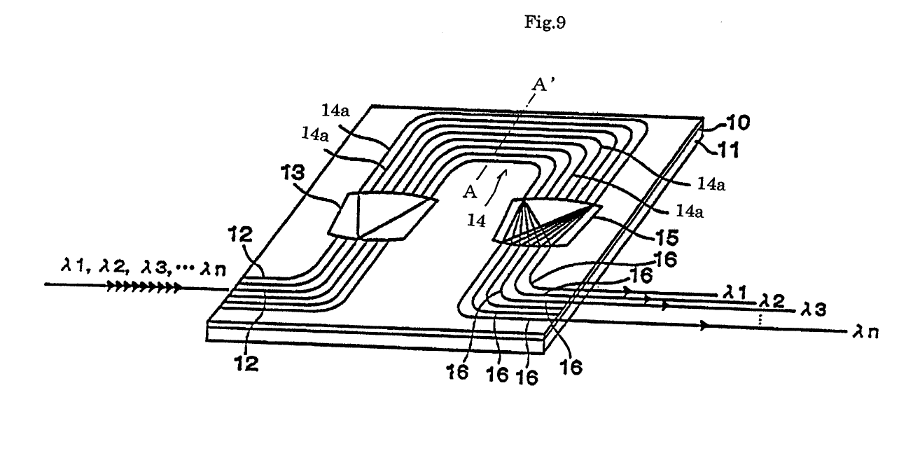

Subsequently, as shown in FIG. 10D, the optical waveguide pattern of the arrayed waveguide grating, that is, the waveguide construction of the cores 2 is formed using photolithography and reactive ion etching. The waveguide construction is the foregoing construction shown in FIG. 9.

The step S1 of forming the waveguide construction of the cores, from FIG. 10A through FIG. 10D, is followed by the step S2 of forming the film of an upper clad 3 in an aspect where the upper clad film covers the waveguide construction of the cores 2 as shown in FIG. 10E. Incidentally, the upper clad film is formed in such a way that, as in the formation of the lower clad 1, the hydrolysis reaction of the raw material of the clad glass is caused in oxyhydrogen flame so as to deposit and form the glass particles of the upper clad 3 (upper clad glass particles). Thereafter, the step S3 of consolidating the upper clad film at a high temperature of, for example, 1200° C. is performed, whereby an optical waveguide is manufactured.

Heretofore, in manufacturing an arrayed waveguide grating, a method as explained below has been applied at the step S3 of consolidating an upper clad film. Letting T1 denote a temperature at which the density change of the glass particles of the upper clad film starts, and T2 denote a temperature at which the density change ends, a sintering rate in a temperature rise from the point T1 to the point T2 is set at about 2.5° C./min so as to cosolidate the upper clad film and to manufacture the arrayed waveguide grating.

Meanwhile, in recent years, it has been required in optical wavelength division multiplexing transmission to increase the number of wavelengths to-be-multiplexed and to narrow wavelength intervals. It has consequently been required to narrow the wavelength intervals of lights which are multiplexed/demultiplexed by an arrayed waveguide grating. Concretely, an arrayed waveguide grating of 40 ch-50 GHz in the band of 1.55 μm (which has the function of multiplexing/demultiplexing lights of 40 wavelengths different from one another at intervals of 50 GHz) has been demanded.

However, when the inventor manufactured the arrayed waveguide grating of 40 ch-50 GHz by employing the prior-art manufacturing method, there has been revealed the problem that the value of adjacent crosstalk degrades. This problem will be concretely explained below.

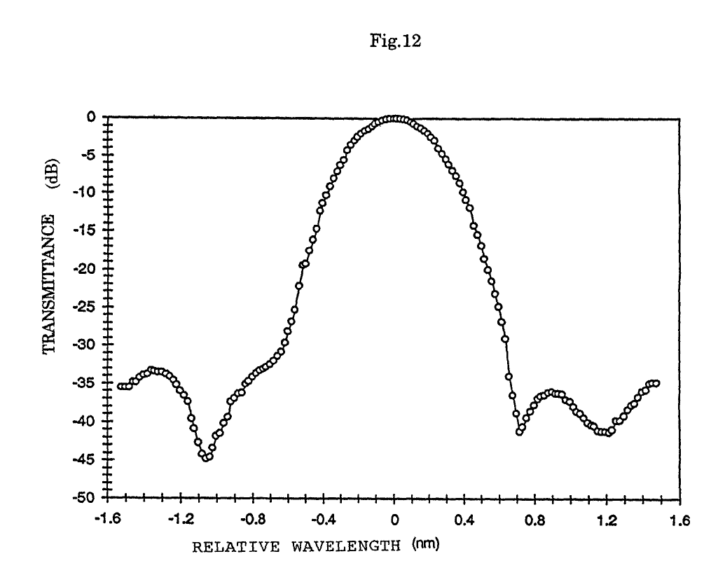

FIGS. 11 and 12 show examples of optical spectrum in the vicinities of the light transmission center wavelengths of arrayed waveguide gratings produced by the prior-art manufacturing method. The optical spectrum shown in FIG. 11 is the optical spectrum example of the arrayed waveguide grating of 40 ch-50 GHz, while the optical spectrum shown in FIG. 12 is the optical spectrum example of the arrayed waveguide grating of 40 ch-100 GHz. Each of the optical spectrum is indicated by the transmittance of the arrayed waveguide grating normalized by the minimum loss.

As seen from the figures, with the example of the arrayed waveguide grating of 40 ch-50 GHz (refer to FIG. 11), the value of the worst adjacent crosstalk within a range of ±(0.4±0.05) nm with respect to the light transmission center wavelength is estimated to be on the order of −23 dB. On the other hand, with the example of the arrayed waveguide grating of 40 ch-100 GHz (refer to FIG. 12), the value of the worst adjacent crosstalk within a range of ±(0.8±0.1) nm with respect to the light transmission center wavelength is estimated to be on the order of −27 dB.

Incidentally, the range for determining the adjacent crosstalk has been set with reference to wavelength intervals at which lights are multiplexed/demultiplexed by the corresponding arrayed waveguide grating. More specifically, in the arrayed waveguide grating of 40 ch-50 GHz, the frequency intervals at which the lights are multiplexed/demultiplexed are 50 GHz, and hence, the adjacent crosstalk determining range has been set at the range of ±(0.4 ±0.05) nm with reference to 0.4 nm in terms of the wavelength intervals. On the other hand, in the arrayed waveguide grating of 40 ch-100 GHz, the frequency intervals at which the lights are multiplexed/demultiplexed are 100 GHz, and hence, the range has been set at the range of ±(0.8±0.1) nm with reference to 0.8 nm in terms of the wavelength intervals.

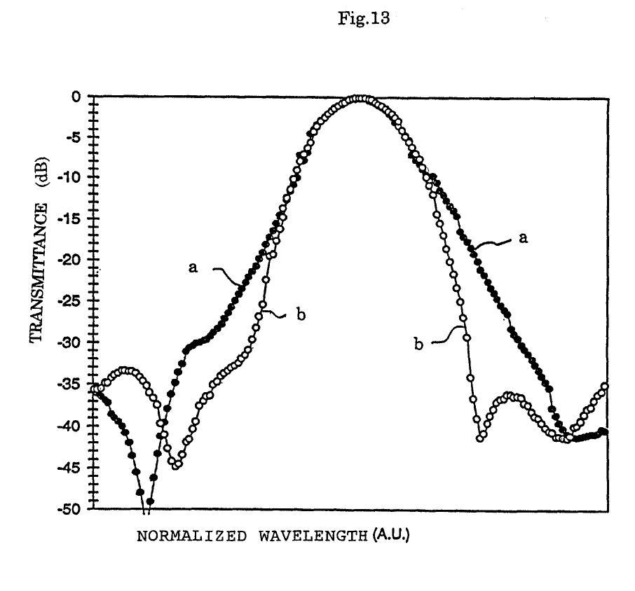

Here, in order to compare the shape of the optical spectrum shown in FIG. 11 with that of the optical spectrum shown in FIG. 12, the scales of the axes of abscissas are normalized on the basis of the wavelength intervals at which the lights are multiplexed/demultiplexed by the respective arrayed waveguide gratings, and the two graphs of FIGS. 11 and 12 are superposed on each other. Then, the example of the optical spectrum shape demonstrated by the arrayed wavelength grating of 40 ch-50 GHz becomes as indicated by a characteristic curve a in FIG. 13. It is seen that the optical spectrum shape of the characteristic curve a in the wavelength band adjacent to the light transmission center wavelength is wider than in the example of the optical spectrum shape (characteristic curve b) demonstrated by the arrayed wavelength grating of 40ch-100 GHz.

As explained before, therefore, the adjacent crosstalk of the arrayed waveguide grating of 40 ch-50 GHz exemplarily studied degrades more than that of the arrayed waveguide grating of 40 ch-100 GHz.

The value of the adjacent crosstalk is one of very important parameters which determine a bit error rate in the case of applying the arrayed waveguide grating to a wavelength division multiplexing transmission systems. Accordingly, enhancement in the adjacent crosstalk is an important theme even in the arrayed wavelength grating of 40 ch-50 GHz in which the multiplexing/demultiplexing wavelength intervals are narrowed. That is, it is required also of the arrayed wavelength grating of 40 ch-50 GHz to exhibit good characteristics on the same order as the exemplified adjacent crosstalk of the arrayed waveguide grating of 40 ch-100 GHz.

Meanwhile, in the arrayed waveguide grating, the phase Δφ of light propagated through an arrayed waveguide is indicated by the following equation (1):

Δφ=(2π/λ)·n_{eff}·ΔL (1)

Here, λ denotes the wavelength of the light, n_{eff} the effective refractive index of the arrayed waveguide, and ΔL the optical path length difference of adjacent channel waveguides constituting the arrayed waveguide. In a case where the values of the phases Δφ have fluctuated in the individual channel waveguides, a disturbance arises in the phasefront of the whole arrayed waveguide. The disturbance defocuses the condensed image of lights outputted from the arrayed waveguide, and degrades the adjacent crosstalk of the arrayed waveguide grating.

When the fluctuations of the values of the phases Δφ are defined as phase errors, the phase errors can be elucidated from the fluctuation of the effective refractive index of the arrayed waveguide. The effective refractive index of the arrayed waveguide is a function of the refractive index and film thickness of the arrayed waveguide and the line width of the channel waveguides, and the phase errors are ascribable to the delicate fluctuations of the variables.

In this regard, the inventor examined the sectional profile of a part indicated by a dot-and-dash line A-A′ in FIG. 9, in the arrayed waveguide grating of 40 ch-50 GHz produced by the prior-art manufacturing method and made studies on the fluctuations of the refractive index, film thickness and line width of the arrayed waveguide.

As a result, it has been revealed that, in the arrayed waveguide grating of 40 ch-50 GHz produced by the prior-art manufacturing method, the individual channel waveguides 14a of the arrayed waveguide 14 are arrayed as indicated by the cores 2 in a schematic view shown in FIG. 4, so the channel waveguides 14a have shapes which incline more toward the central side of the array at positions nearer to the end sides of the array. It is considered that, when the channel waveguides 14a incline in this manner, a fluctuation will appear in the effective refractive index of the arrayed waveguide 14, thereby to incur the phase errors.

Besides, since the channel waveguides 14a constituting the arrayed waveguide 14 have the shapes which incline more toward the central side of the array at the positions nearer to the end sides of the array, it is considered that the phase errors of the channel waveguides 14a will enlarge more toward the end sides of the array of these channel waveguides, so a relationship as shown in FIG. 5 by way of example will appear. Incidentally, the figure shows the relationship between array Nos. and the phase errors in the case where the number of the arrayed channel waveguides 14a is set at 400 and where the array Nos. of 1, 2, 3, . . . and 400 are successively assigned from one end side of the array.

The relationship becomes a phase error distribution in which the phase errors enlarge more from the central position of the array of the channel waveguides of the arrayed waveguide toward the end sides of the array. Hereinbelow, the distribution shall be termed a “correlative phase error”.

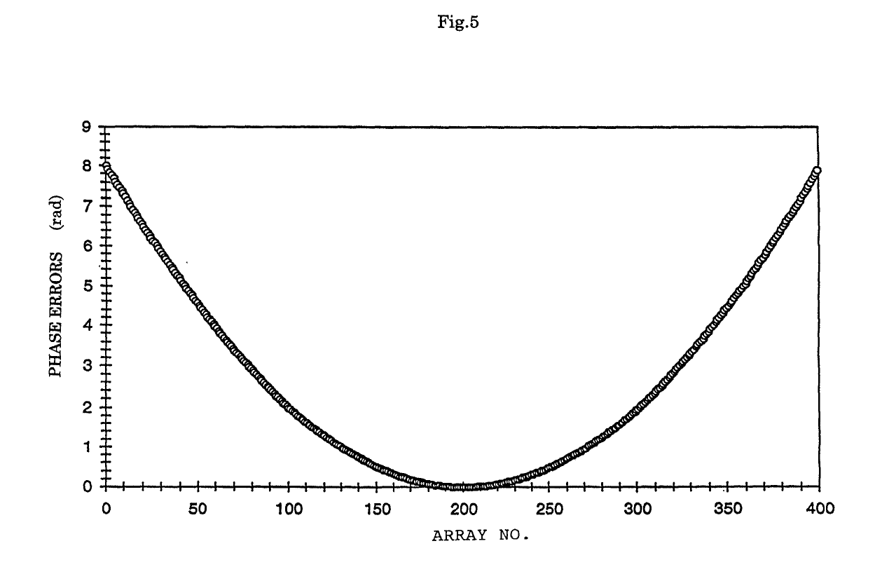

Further, the optical spectrum of the arrayed waveguide grating in the presence of the correlative phase error shown in FIG. 5 was computed by simulation, and the result is shown at a characteristic curve a in FIG. 6. Also, a theoretical spectral shape in the absence of the correlative phase error is shown at a characteristic curve b in the figure. As seen from the figure, the shape of the optical spectrum of the arrayed waveguide grating widens due to the presence of the correlative phase error, and the adjacent crosstalk degrades greatly.

On the basis of the above studies, the inventor has found out that the adjacent crosstalk can be enhanced in the arrayed waveguide grating in which the frequency intervals of lights to be multiplexed/demultiplexed are narrowed, by suppressing the correlative phase error.

Besides, the fluctuations of the phase errors are ascribable to fluctuations in a process for manufacturing the arrayed waveguide grating. Upon various studies, the inventor has found out that the correlative phase error can be suppressed by making appropriate the conditions of the step of consolidating the upper clad.

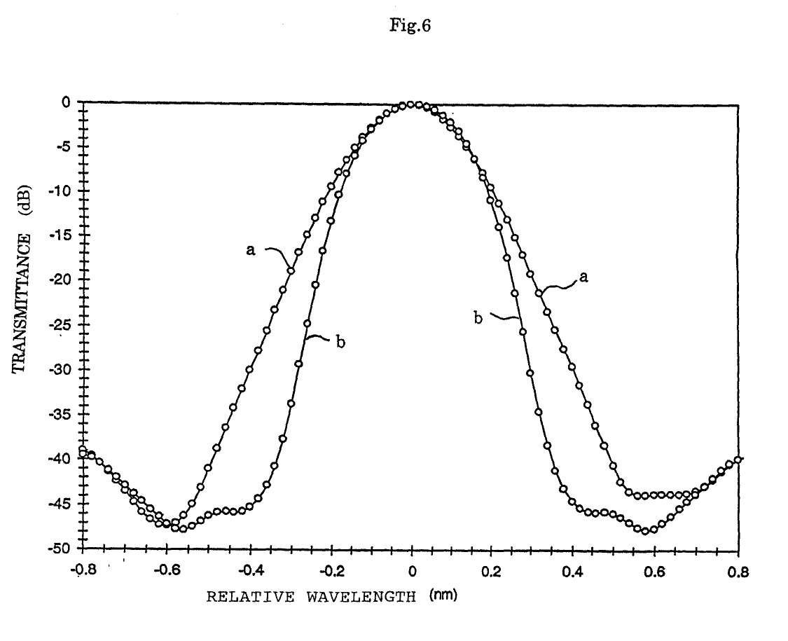

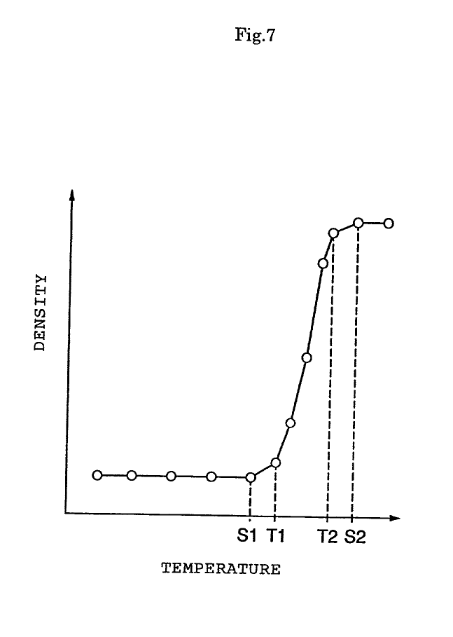

The inventor's studies will be explained below. The glass particles produced by the flame hydrolysis deposition undergo an abrupt density change as indicated by a characteristic curve in FIG. 7, during sintering. This is because the behavior of the sintering is predominated by viscous flow sintering. By the way, in the figure, symbol S1 denotes the start temperature of the sintering, and symbol S2 the end temperature thereof. Besides, the start temperature T1 and end temperature T2 of the abrupt density change are determined chiefly by the composition and diameters of the glass particles.

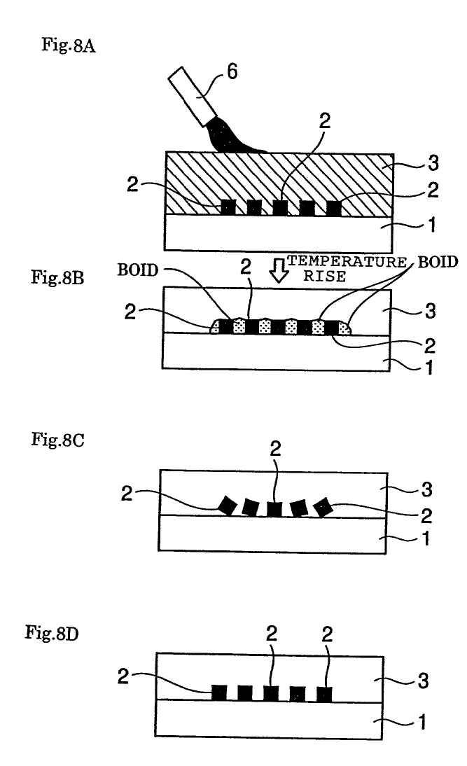

As shown in FIG. 8A, the film of an upper clad 3 is deposited and formed so as to cover the waveguide construction of cores 2. Therefore, when the abrupt density change mentioned above takes place during the consolidating of the film of the upper clad 3, gaps appear on both the sides of core channels (the waveguide construction of the cores 2) forming an arrayed waveguide, with a temperature rise as shown in FIG. 8B.

When the temperature of the consolidating is raised in this state, a glass ought to flow into the gaps gradually until the voids are finally filled up with the glass to complete the sintering. However, the supply of the glass into the gaps fails when a sintering rate is high in a temperature rise from the point T1 at which the density change of the glass particles forming the film of the upper clad 3 starts, to the point T2 at which the density change ends. It has accordingly been revealed that, when the sintering rate is high in the temperature rise from the point T1 to the point T2, the sintering ends in a state where the upper clad 3 rolls the arrayed cores 2 in.

As a result, in the case of the high sintering rate, as shown in FIG. 8C, the cores 2 incline more at positions nearer to the end sides of the array thereof, and channel waveguides 14a come to have shapes which incline more toward the central side of the array at the positions nearer to the end sides of the array. Incidentally, FIG. 8D schematically shows the ideal arrayal aspect of the cores 2 of the channel waveguides 14a.

Accordingly, the inventor conducted an experiment explained below, with the intention of reliably performing the supply of the glass into the gaps and suppressing the inclinations of the shapes of the channel waveguides 14a by making appropriate the sintering rate in the temperature rise from the point T1 at which the density change of the glass particles of the upper clad film starts, to the point T2 at which the density change ends.

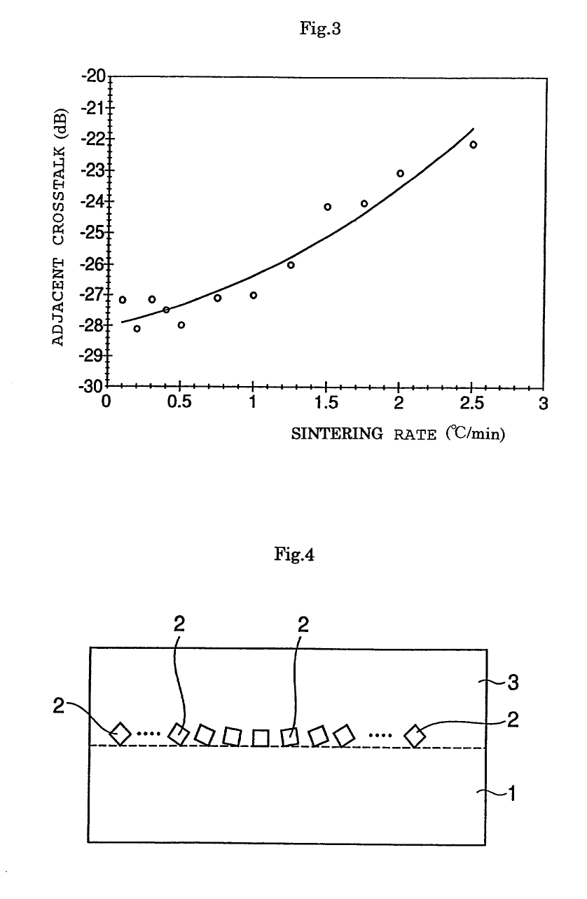

In manufacturing samples of an arrayed waveguide grating of 40 ch-50 GHz, the sintering rate was variously changed within a range of from 2.5° C./min to 0.1° C./min. Besides, the relationship between the sintering rate and the adjacent crosstalk of the manufactured arrayed waveguide grating was found. As a result, relation data shown in FIG. 3 has been obtained, and it has been revealed that the adjacent crosstalk can be suppressed to or below −27 dB when the sintering rate is set at or below 1° C./min. The adjacent crosstalk value of −27 dB or below is equivalent or superior to the adjacent crosstalk of an arrayed waveguide grating of 40 ch-100 GHz.

The present invention has its construction determined on the basis of the above studies. An optical waveguide in one aspect of the present invention, and a manufacturing method therefor are an optical waveguide which can narrow wavelength intervals to-be-multiplexed/demultiplexed and which exhibit good adjacent crosstalk characteristics, and a manufacturing method therefor. Besides, the optical waveguide is, for example, an arrayed waveguide grating.

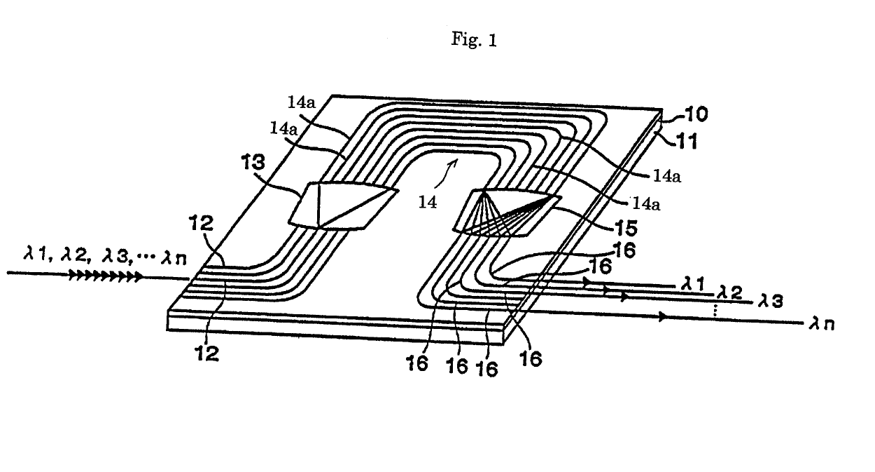

Now, an aspect of performance of the present invention will be described in conjunction with the drawings. By the way, in the ensuing description of embodiments, the same symbols will be assigned to the parts of the prior-art example having identical names and shall not be repeatedly explained. FIG. 1 shows the essential construction of one embodiment of an optical waveguide according to the present invention. The optical waveguide of the embodiment is a 40 ch-50 GHz arrayed waveguide grating, the construction of which is substantially the same as that of the arrayed waveguide grating shown in FIG. 9.

Besides, the embodiment is produced by a manufacturing method which is similar to the prior-art manufacturing method explained before, but it is characterized by setting a sintering rate as follows, at the step S3 of consolidating an upper clad film in the manufacture of the arrayed waveguide grating: Letting T1 denote a temperature at which the density change of the glass particles of the upper clad film starts, and T2 denote a temperature at which the density change ends, the sintering rate in a temperature rise from the point T1 to the point T2 is set at 1.0° C./min so as to sinter and transparentize the upper clad film at the step S3.

Incidentally, the temperatures T1, T2 are appropriately set on the basis of data obtained by experiments or the likes beforehand, as shown in FIG. 7. In the manufacture of the embodiment, the temperatures T1 and T2 are respectively set at 1000° C. and 1125° C.

The embodiment is produced by the above manufacturing method, and the sintering rate from the temperature T1 at which the density change of the glass particles of the upper clad film starts, to the temperature T2 at which the density change ends, at the step of consolidating the upper clad film is set at 1.0° C./min as explained above. As understood from the studied result shown in FIG. 3, therefore, the embodiment can be manufactured as an excellent, arrayed waveguide grating which suppresses the correlative phase error of an arrayed waveguide 14 and whose adjacent crosstalk is of small value.

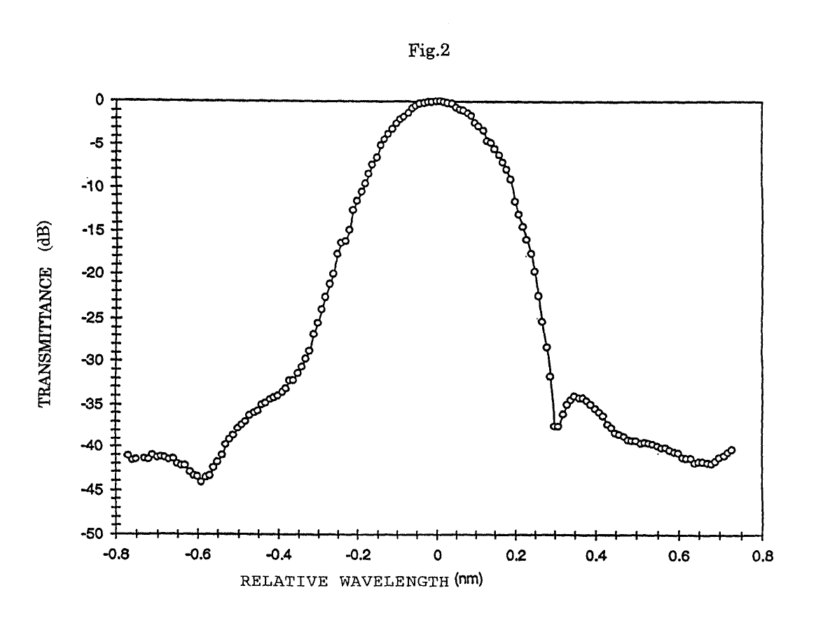

FIG. 2 shows a result obtained by measuring a optical spectrum in the vicinity of a light transmission center wavelength as to the arrayed wavelength grating of the embodiment. As seen from the figure, the arrayed wavelength grating of the embodiment can lower the adjacent crosstalk to about −27 dB. From this result, it has been verified that the adjacent crosstalk can be enhanced to the same degree as the adjacent crosstalk of an arrayed waveguide grating of 40 ch-100 GHz by applying the manufacturing method of the embodiment.

Incidentally, the present invention is not restricted to the foregoing embodiment, but it can adopt various aspects of performance. By way of example, the sintering rate from the temperature T1 at which the density change of the glass particles of the upper clad film starts, to the temperature T2 at which the density change ends, at the step of consolidating the upper clad film, is set at 1.0° C./min in the embodiment, but it can be set at an appropriate value of 1.0° C./min or below in accordance with the composition and diameters of the glass particles of the upper clad film.

Likewise, the temperature T1 at which the density change of the glass particles of the upper clad film starts, and the temperature T2 at which the density change ends, at the step of consolidating the upper clad film, are set at appropriate values in accordance with the composition and diameters of the glass particles of the upper clad film.

Besides, the production of the arrayed waveguide grating by applying the manufacturing method of the embodiment has been exemplified in the above, but the manufacturing method for the optical waveguide according to the present invention as indicated in the embodiment is also applicable to the manufacture of an optical waveguide other than the arrayed waveguide grating. A Mach-Zehnder interference type optical waveguide, a Y-branch optical waveguide, and various optical waveguides having directional couplers are mentioned as examples of the optical waveguide to which the present invention is applied. The same effects as those of the embodiment can be brought forth by applying the present invention to an optical waveguide which includes a waveguide construction having a plurality of waveguides arranged side by side.

That is, since the correlative phase error as explained above can be suppressed by producing the optical waveguide by the use of the manufacturing method for the optical waveguide according to the present invention, the optical waveguide which includes the waveguide construction having the plurality of waveguides arranged side by side can be made an optical waveguide of superior adjacent crosstalk characteristics as indicated in the embodiment of the arrayed waveguide grating.

What is claimed is:

1. A method of manufacturing an optical waveguide, comprising:
the step S1 of forming a predetermined waveguide pattern on a core which overlies a lower clad formed on a substrate;
the step S2 of forming an upper clad film which covers the waveguide pattern, by flame hydrolysis deposition after said step S1; and
the step S3 of consolidating the upper clad film after said step S2;
wherein letting T1 denote a temperature at which a density change of glass particles of said upper clad film starts at said step S3, and
letting T2 denote a temperature at which the density change ends,
a sintering rate in a temperature rise from the temperature T1 to the temperature T2 is set at, at most, 1.0° C./min so as to consolidate said upper clad film.

2. An optical waveguide comprising:
a waveguide pattern which includes a plurality of waveguides arranged side by side at intervals from one another;
wherein said waveguide pattern is fabricated by the method of manufacturing an optical waveguide according to claim 1.

3. An optical waveguide according to claim 2, wherein said waveguide pattern includes:
at least one optical input waveguide;
a first slab waveguide which is connected to an output side of said at least optical input waveguide;
an arrayed waveguide which consists of a plurality of channel waveguides arranged side by side, connected to an output side of said first slab waveguide and having lengths different preset amounts from one another;
a second slab waveguide which is connected to an output side of said arrayed waveguide; and
a plurality of optical output waveguides arranged side by side, which are connected to an output side of said second slab waveguide;
wherein at least said channel waveguides and said optical output waveguides are pluralities of waveguides which are arranged side by side at intervals from one another.
